(19) United States
(12) Patent Application Publication
(10) Pub. No.: US 2023/0013443 A1
(43) Pub. Date: Jan. 19, 2023

(54) SYSTEMS AND PROCESSES FOR RECONCILING FIELD COSTS

(71) Applicant: Chevron U.S.A. Inc., San Ramon, CA (US)

(72) Inventors: Matthew Scott Bolen, The Woodlands, TX (US); Emily Victoria Fleming, Houston, TX (US); Robert Miles McGowen, JR., Cypress, TX (US); Christine Noshi, Houston, TX (US)

(21) Appl. No.: 17/379,872

(22) Filed: Jul. 19, 2021

(51) Int. Cl. G06Q 40/00; G06F 16/23; G06N 20/00

(52) U.S. Cl. CPC G06Q 40/12; G06F 16/2379; G06N 20/00; G06Q 50/02

(57) ABSTRACT

The systems and methods generally apply a machine learning algorithm that is configured to automatically reconcile and update field costs. The algorithm may also predict when field cost data has not captured all or substantially all of the costs based on historical data. The systems and methods may either flag the missing cost or automatically populate at least a portion or up to all of any missing field costs. Thus, machine learning and data analytic techniques may be implemented to reconcile field costs by using, for example, invoice and financial information.

### TECHNICAL FIELD

The present application relates generally to reconciling and updating field costs in more effective and/or timely manners.

### BACKGROUND AND SUMMARY

Costs that are captured in the field are immediate but often fail to account for or capture all costs. Although invoice and financial costs associated are accurate, they frequently do not show up in invoice and financial systems of record until much later, such as 3-6 months, after occurrence of field activity. This lag or delay can lead to various inefficiencies. In addition, the field costs are sometimes used to give a glimpse of what is being spent today and what will be spent in the future. Unfortunately, in many cases a lot of time and effort are spent manually reconciling costs, such as updating field costs with invoice and financial system of record costs. These and other deficiencies exist.

The present application pertains to systems and methods that address one or more of the aforementioned deficiencies. In one embodiment, the application pertains to a method for reconciling or updating field costs. The method comprises aggregating historical cost data in a database; inputting a field cost into the database; applying an algorithm to predict when the inputted field cost is incorrect based on historical cost data; and providing a signal to the user that the inputted field cost is incorrect, automatically correct the incorrect field cost, or both.

In another embodiment the application pertains to a system for reconciling or updating field costs. The system comprises a processor; a database; an algorithm to predict when inputted field cost is incorrect based on historical cost data; and a machine learning application to periodically or continuously update the algorithm.

### BRIEF DESCRIPTION OF THE FIGURES

FIG. 1 pertains to historical cost reconciliation on the left figure while the right figure depicts using real time reconciliation.

FIG. 2 depicts well attributes and daily activity.

FIG. 3 depicts an anomalies detection embodiment of the present application.

### DETAILED DESCRIPTION

As disclosed herein, the systems and methods apply a machine learning algorithm that is configured to automatically reconcile and update field costs, and in some embodiments may also predict when the field cost data has not captured part or substantially all of the costs based on historical data. Additionally, the machine learning model may help identify potential reasons for any discrepancy in cost taxonomies between, for instance, field system of record and invoicing system of record. The systems and methods may either flag the missing cost and/or automatically populate at least a portion of and in some case up to all of any missing field costs. In this manner, machine learning and data analytic techniques are implemented and/or utilized to reconcile field costs by using invoice and other financial information.

In some examples, the machine learning algorithm may be configured to analyze previous wells and compare it to the current wells that are being drilled based on a plurality of attributes including well drilling design, completion design, production history and reservoir characteristics. Projections may be made which may be adjusted if the projections yield too high costs, too low costs, and/or may result in overcharging for certain activities. The systems and methods herein may be utilized on a historical basis and/or or a real-time basis. For example, under the historical basis, auto-reconciliation may be used to update the field systems of record to reflect what is in the financial system of record. Under the real-time basis, upon selection of history wells that match the current well of interest based on certain attributes, historical cost trends may be used to guide the ranges to be expected for the costs in the field. In this manner, the accuracy of the field estimate may be improved in some embodiments the field estimates may be within a certain threshold percentage, such as plus or minus 3%, 5%, or 10%. In this manner, the field systems and records may be used for a variety of business needs such as budgeting, auditing, predicting, forecasting, capital allocation, and/or improving metrics for various activities.

Given the different cost taxonomies between the various systems, the machine learning algorithm may be configured to be trained such that it identifies the cost taxonomy that translates to the financial system of record and/or identifies the cost taxonomy that translates to the invoicing system of record. Thus, the machine learning algorithm may be taught to identify which cost taxonomy translates into various categories in the field cost taxonomy. In this manner it may apply mapping to the field cost taxonomy without requiring manual intervention to do so. For example, under the real-time basis, well attributes and location attributes of historical wells that were drilled may be used to train the machine learning algorithm to identify similar types of wells that are either currently or planned to be drilled. Afterwards, the well activities; planned and unplanned, implemented throughout the different phases of well development operations can be used to, for example, trend costs over time, derive minimum and maximum limits, and/or define or apply any number of exceptions. In this manner, the machine learning algorithm may be configured to match the well that is being drilled and completed, along with a prediction of the cost based on the historical data that is available from a plurality of systems of record for similar historical wells. Without limitation, this data may be retrieved from a first system of record, a second system of record, and/or a third system of record. In some examples, the first system of record may comprise field system of record cost data. The second system of record may comprise invoice cost data. The third system of record may comprise financial system of record cost data.

For example, for a horizontal 3 casing string 7,500 foot lateral well, an expected cost for a given well may be expected to be about $250,000. The field system of record is continuously monitored and if the expected charge does not come in within an expected time period, then it may be flagged for the cost not coming in and/or flagged also for the cost not coming in within a predetermined time period. In some examples, this information may be entered by the field system of record. In other examples, this information may be retrieved from an invoice system of record. Moreover, in some embodiments the time duration to check by the field system of record may be of a shorter duration than that of the invoice system of record.

Numerous additional actions may be undertaken as a result of the implementation by the machine learning algorithm. For example, the prediction by the machine learning algorithm may result in capital forecast and/or business planning. For example, the machine learning algorithm may be configured to identify some or all attributes of all the wells that are going to be drilled over a given time, such as in the next year, in which a forecast may be generated in terms of capital spend. This can be helpful to determine whether the spend is over or under a particular limit. This information can then be used early on or during drilling so as to avoid exceeding a particular cap or limit set for spending. This may be advantageous compared to waiting until after expiration of the given time to make any adjustments or corrective actions for the capital budget.

While this application applies broadly to many industries and many applications it may be described herein with specific reference to rigs in an oil field application as just one example. For example, any number of rigs may be dropped, decreased in activity, or increased in activity to account for the capital budget and forecasting purposes. In this manner, accuracy and efficiency of the generation and application of any type of capital forecast may be improved. In addition, there may be situations in which auto-accruals (either throughout interim points of a given time period or at the end of the given time period) of drilling and completion costs are performed when there is a lag time when work is finished in the field. Advantageously, in these cases using the systems and methods herein the invoices may still be put in the financial system of record, thereby improving the time to payment.

Various additional advantages may be achieved by the systems and methods disclosed herein. For example, the machine learning algorithm may be configured to reduce processing load and increase system efficiency, while also drawing out information from various disparate sources, such as the three different systems of record.

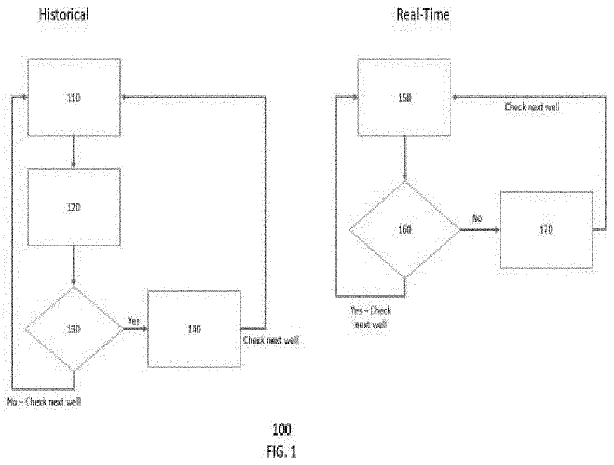

### FIG. 1

At block 110, the method for cost reconciliation may include waiting for a period of time for costs to be finalized. For example, the method may include waiting for 3-6 months for well costs to be finalized in the invoice and financial systems of record. At block 120, the method may include utilizing machine learning algorithm to check the invoice or financial system of record against the field system of record. At block 130, the method may include determining the cost difference before proceeding to the next well. For example, the method may determine the cost difference so that at block 140 the field system of record may be updated to match the invoice or financial system of record before proceeding to the next well.

At block 150, the method may include trending the invoice and financial system of record data. For example, the method may include trending the invoice and financial system of record data using the machine learning algorithm. At block 160, the method may include evaluating whether the field system of record is within defined limits. For example, this may include evaluating whether the field system of record outside a predetermined threshold including upper and lower limit values. At block 170, the method may include updating field system of record with certain values. For example, the method may include updating the field system of record with median values if the field system of record is not within the defined limits before proceeding to the next well.

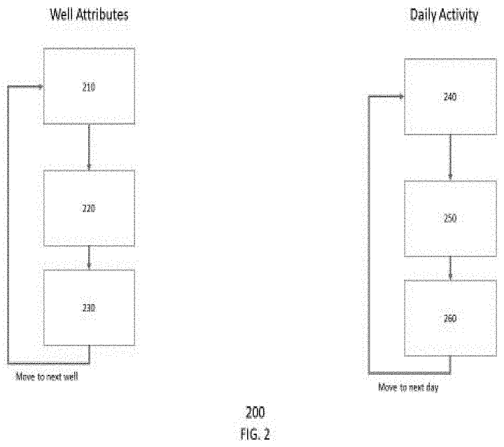

### FIG. 2—Well Attributes and Daily Activity

At block 210, the method may include checking one or more well attributes. For example, a processor may be configured to check one or more well attributes. The one or more well attributes may include, without limitation, identifying a location of the well, a size of casing, total depth of the well, phase of the well, and/or measured depth of the well. At block 220, the method may include matching the one or more well attributes to the cost in invoice and financial systems of record. At block 230, the method may include utilizing the machine learning algorithm to populate field system of record costs based on the one or more well attributes. For example, the machine learning algorithm may be configured to identify a type and design of well at a given location. This information may be used to find similar types and designs wells in the invoice and financial systems of record and then populate the field systems of record based on that information.

At block 240, the method may include reading activity from the field system of record. For example, the processor may read activity on a predetermined or periodic time basis, such as hourly, daily, weekly, or monthly basis from the field system of record. At block 250, the method may include utilizing the machine learning algorithm to match activity to the invoice and financial system of record. For example, the processor may be configured to utilize the machine learning algorithm to match the hourly, daily, weekly, or monthly basis. At block 260, the method may include populating the field cost system of record with the invoice and financial system of record. For example, the processor may be configured to indicate to the user what should have been the cost or what the issues are, if any, with the cost. In another example, the processor may be configured to improve the time for entering the cost into the field system of record.

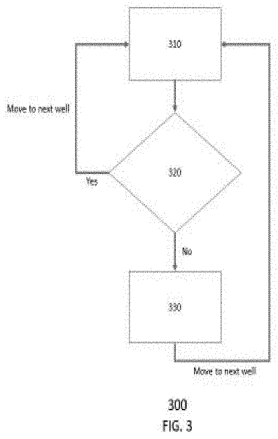

### FIG. 3—Anomalies Detection

At block 310, the method for anomalies detection may utilize the machine learning algorithm to perform a check between the various disparate sources or systems of record. For example, the method may include using the machine learning algorithm to perform a three-way check between the field system of record, the invoice system of record, and the financial system of record. In some examples, this check may include the information for the wells that have come in. In other examples, this check may include information for the wells under a historical basis as well.

At block 320, the method may include identifying whether the cost is within a predefined upper limit and lower limit between all systems of record. For example, this may include evaluating whether the cost is within a predetermined range constituting the upper and lower threshold values between the field system of record, the invoice system of record, and/or the financial system of record. In some examples, this evaluation may be based on historical trend. In other examples, this evaluation may be based on invoices received. In this manner, the invoice system of record may be compared against field system of record with respect to the defined limits.

Given the challenge of the cost taxonomy for each system of record, the processor may be configured to check between any two or all three systems of record. It may also be configured to train the machine learning algorithm to learn which cost belongs where in each of the three systems of record. At block 330, the method may include generating one or more alerts to indicative of the anomaly in the cost data. For example, if the cost is not within the defined limits, an alert may be generated before moving on to the next well.

The machine learning algorithm may be configured to create auto-map costs, instead of having a separate mapping file. In this manner, the machine learning algorithm may be trained to create its own virtual mapping file within the algorithm, and then for future costs it may be configured to reference its own self-learned mapping algorithm. Advantageously, in this manner the algorithm may be configured to generate additional predictions or forecasts based on self-referencing of the machine learning algorithm.

1. A method for reconciling or updating field costs comprising:
aggregating historical cost data in a database;
inputting a field cost into the database;
applying an algorithm to predict when the inputted field cost is incorrect based on historical cost data; and
providing a signal to the user that the inputted field cost is incorrect, automatically correct the incorrect field cost, or both.

2. The method of claim 1 which further comprises storing the inputted field cost and automatic corrections in the database with historical cost data and modifying the algorithm.

3. A system for reconciling or updating field costs comprising:
a processor;
a database;
an algorithm to predict when inputted field cost is incorrect based on historical cost data; and
a machine learning application to periodically or continuously update the algorithm.
